(19) United States
(12) Patent Application Publication
(10) Pub. No.: US 2017/0017970 A1
(43) Pub. Date: Jan. 19, 2017

(54) METHODS AND APPARATUS TO IDENTIFY NON-NAMED COMPETITORS

(71) Applicant: The Nielsen Company (US), LLC, New York, NY (US)

(72) Inventors: Thomas W. Sarnowski, New York, NY (US); Martin Quinn, Sugar Grove, IL (US); Thomas Goering, New York, NY (US); Bruce C. Richardson, Arlington Heights, IL (US)

(21) Appl. No.: 14/985,426

(22) Filed: Dec. 31, 2015

Related U.S. Application Data
(60) Provisional application No. 62/191,848, filed on Jul. 13, 2015.

(51) Int. Cl. G06Q 30/02

(52) U.S. Cl. CPC G06Q 30/0201; G06Q 30/0202

(57) ABSTRACT

Methods, apparatus, systems and articles of manufacture are disclosed to identify non-named competitors. An example method includes identifying, with a processor, a target item to evaluate in connection with historical market activity data, and improving model evaluation efficiency by optimizing, with the processor, erroneous selection of competitive products by: identifying a rest-of-category (ROC) subset of items in the historical market activity data that exclude a same manufacturer as the target item, identifying a rest-of-manufacturer (ROM) subset of items in the historical market activity data that are associated with the same manufacturer as the target item and exclude a same brand as the target item, and identifying a rest-of-brand (ROB) subset of items in the historical market activity data that are associated with the same brand as the target item and exclude the target item.

### RELATED APPLICATION

This patent claims the benefit of, and priority to, U.S. Provisional Application Ser. No. 62/191,848, entitled “Non-Named Competitors” and filed on Jul. 13, 2015, which is hereby incorporated herein by reference in its entirety.

### FIELD OF THE DISCLOSURE

This disclosure relates generally to predictive modeling of retail data within the consumer-packaged goods industry, and, more particularly, to methods and apparatus to identify non-named competitors.

### BACKGROUND

In recent years, modeling techniques have been applied to retail data to capture and/or otherwise determine the impact of competitors pricing and merchandising activity on sales of a target item. An analyst typically generates a statistical model to estimate regular price elasticity, promotional price elasticity, price thresholds and lift factors for store-level price and merchandising activities. Store-level activities include activities related to product promotion, such as in-store displays, in-store features, bonus-packs, trial-packs, etc. When generating the predictive model of sales for the target item, the analyst selects one or more competitive products to include in the model so as to assess their impact on target item sales as well as the target item's own pricing and merchandising activity.

### BRIEF DESCRIPTION OF THE DRAWINGS

FIG. 1 is a schematic illustration of a competitive category structure modeling system to identify non-named competitors.

FIG. 2 is an example competitive category grouping framework generated by the competitive category structure modeling system of FIG. 1.

FIG. 3 is an example competitive modeling matrix containing modeling terms generated by the competitive category structure modeling system of FIG. 1.

FIGS. 4-8 are flowcharts representative of example machine readable instructions that may be executed to implement the example competitive category structure modeling system of FIG. 1 to identify non-named competitors.

FIG. 9 is a block diagram of an example processor platform structured to execute the example machine readable instructions of FIGS. 4-8 to implement the example competitive category structure modeling system of FIG. 1.

### DETAILED DESCRIPTION

Promotional activities are frequently executed for certain category of products as a manner of maintaining or gaining a marketing advantage (e.g., increasing demand, gaining consumer trial behavior, etc.) over competitive products. Example promotional activities include temporary price reductions (TPRs), in-store displays, features, bonus-packs, trial-packs, coupons, etc. One or more effects of such promotional activities include, but are not limited to: 1) increased demand for the promoted product, 2) increased brand awareness, 3) increased consumption rate, 4) increased market penetration, 5) increased market share, etc.

Predictive models may be built and/or otherwise utilized by analysts to estimate the effects of competitors' price and merchandising activity, such as regular price changes, promotional price discounts, increased or decreased product distribution on the sales of a target item, etc. Traditional approaches to building predictive models include a need to specify the competitive items (e.g., individual products) that constitute the competitive set of products whose price and merchandising activity could have a significant impact on sales of the target item. Such requirements to specify the individual competitive items rely on an analyst's discretion that is based on, in part, anecdotal evidence, a brand manager's “gut feel,” and/or knowledge of the competitive landscape of the category being modeled. In some examples, competitive products are included that have different degrees of (e.g., marginal) association with the target product of interest under analysis. This can cause a mis-specification of the predictive model such that other model term estimates lack precision and or cause computational waste to systems and/or technological devices that perform modeling. In other examples, the analyst simply misses one or more competitive products in the item selection, thereby resulting in a model that fails to consider all potential influences for the target product of interest. In still other examples, the analyst selects competitive products to be included in model evaluation despite the fact that such competitive products do not participate in historical market activity data to be analyzed (or the analyst selects a competitive term that has a relatively limited promotional activity), in which case wasted model efforts occur to generate coefficient values for non-relevant model terms.

Manual specification of the competitive items during model construction may also fail to capture interactions that would otherwise appear counter-intuitive to some analyst selection choices. While the analyst's manual selection may include competitive products that are unassociated with the same manufacturer as the target item of interest, some item interactions among “same-manufacturer” items may contribute to how a target product will perform in the market. As such, if those “same-manufacturer” items are inadvertently excluded, the true impact afforded the category on the target item of interest will be missed and/or otherwise mis-stated. Similarly, the analyst may not consider modeling certain product types together based on anecdotal expectations that such product types do not compete and/or otherwise affect each other. This manual model mis-specification would again impact the true competitive effect of the category on the target item of interest.

Examples disclosed herein facilitate model building that captures all potential competitive impacts for a target item of interest. As used herein, “competitive” products include any products that may exhibit an influence on the target product to be analyzed, regardless of whether the products are manufactured and/or otherwise sold by the same manufacturer. As such, examples disclosed herein capture the entire competitive dynamics of a category of interest when modeling in view of a target product of interest. Additionally, model building efficiency gains and model evaluation speed/efficiency improvements are realized by examples disclosed herein, particularly when non-relevant items that would otherwise be selected by manual analyst input are excluded from model evaluation. Moreover, examples disclosed herein reduce analyst time spent initiating a model building initiative.

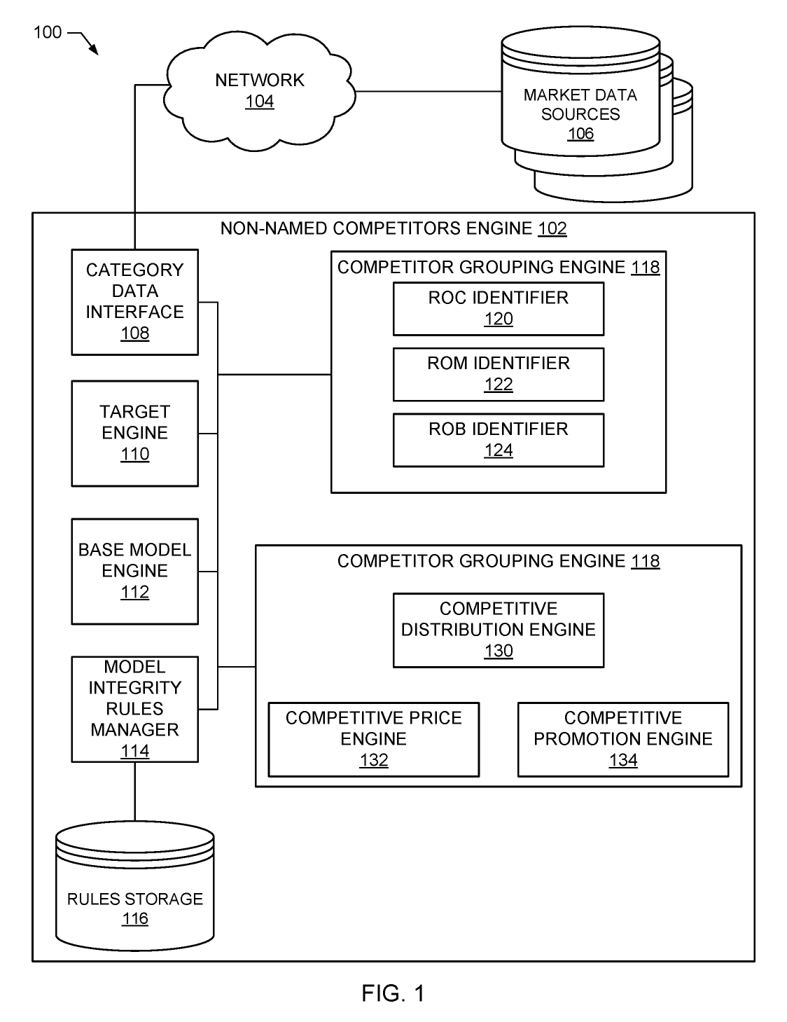

FIG. 1 is an example competitive category structure market system 100 that includes an example non-named competitors (NNC) engine 102 communicatively connected to an example network 104 (e.g., the Internet) and one or more sources of market (e.g., category) data 106. In the illustrated example of FIG. 1, the NNC engine 102 includes an example category data interface 108, an example target engine 110, an example base model engine 112, an example model integrity rules manager 114 communicatively connected to an example rules storage 116. The example NNC engine 102 of FIG. 1 also includes an example competitor grouping engine 118 that includes an example rest-of-category (ROC) identifier 120, an example rest-of-manufacturer (ROM) identifier 122, and an example rest-of-brand (ROB) identifier 124. The example NNC engine 102 of FIG. 1 also includes an example competitive surrogate engine 126 that includes an example competitive distribution engine 130, an example competitive price engine 132, and an example competitive promotion engine 134.

In operation, the example category data interface 108 retrieves and/or otherwise receives historical market data (e.g., historical sales data) from the example market data sources 106 that is associated with a geography of interest. The market data sources 106 may include, but are not limited to, data collected and provided by The Nielsen Company®, such as all commodities volume (ACV) data from Spectra®, point-of-sale (POS) retail data and/or panelist data. The market data includes information related to product market activity, such as a number of units sold, regular price values, promotional price values, promotional activity associated with sales (e.g., TPRs, displays, features, etc.). Additionally, example market data includes product identification information such as store identifiers associated with store(s) that have sold the product, universal product code(s) (UPCs), stock keeping units (SKUs), product description information, product manufacturer, product brand, packaging information (e.g., 6-pack, 4-pack, 2-liter, etc.), channel type in which product was sold (e.g., convenience, drug, food, etc.), category, etc.

In some examples, particular geographies may have particular hierarchical dimension arrangements that are common and/or otherwise expected. Dimensions may include a category type, a channel type, a geography type (e.g., direct market area (DMA), provinces, retailers, etc.) and/or product types (e.g., UPCs, manufacturers, brands, sub-brands, etc.). Regardless of particular dimensions associated with the historical market data, as long as a market category has a corresponding hierarchy, examples disclosed herein may identify corresponding competitor grouping levels of (a) rest-of-category (ROC), (b) rest-of-manufacturer (ROM) and (c) rest-of-brand (ROB), which are applied to competitive measures (e.g., surrogate model terms) to encapsulate dynamics within the category, as described in further detail below.

The example target engine 110 identifies a target item of interest to be estimated with a model in view of the historical market data. As described in further detail below, the target item may be seeded with candidate effects/parameters under the control of an entity that may wish to market the target item (e.g., a manufacturer). For example, parameters under the control of the manufacturer include, but are not limited to, promotion type, promotion intensity and/or promotion duration. In some examples, the analyst may consider changing a merchandizing strategy and desire feedback related to how the product of interest will either (a) affect competitive products and/or (b) be effected by competitive products already in the market. For instance, the analyst might decide that a candidate merchandizing strategy is to infuse three (3) additional promotions into a particular market geography in an effort to appreciate how sales will change. More specifically, the analyst may wish to understand how such candidate strategies will affect (a) the whole category, (b) only those products by the manufacturer and/or (c) only those products within the same brand as the target product of interest. In still other examples, the analyst may seed the analysis with competitive product expectations, such as simulating an effect of a competitor introducing three new products into the category of interest (e.g., a distribution measure controlled by the competitor).

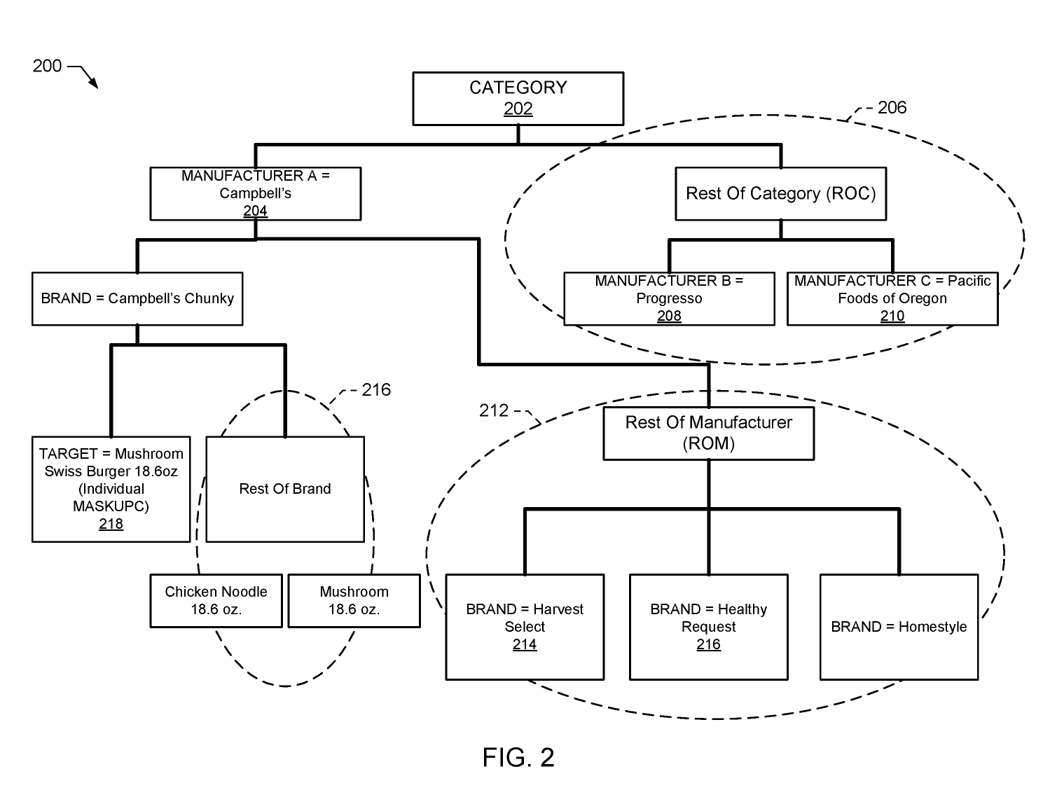

To prevent analyst discretion that may result in an erroneous selection of competitive products and/or cause computational waste, the example competitor grouping engine 118 classifies competitive grouping levels of the historical market data. In particular, the example competitor grouping engine 118 generates classification groupings of the historical market data in view of a target product of interest in a manner consistent with an example competitive category grouping framework 200 of FIG. 2.

In the illustrated example of FIG. 2, the competitor grouping engine 118 identifies a category of “soup” 202 is associated with an example target product of interest 218 having an associated manufacturer 204 (Campbell's). The example ROC identifier 120 identifies a rest-of-category (ROC) grouping 206, which includes all items in the soup category exclusive of those items by the same manufacturer as the target product of interest 218. Products matching these qualifiers are tagged as ROC products, and will be analyzed in connection with competitive measures of distribution, value on promotion, regular price and promoted price index, as described in further detail below. Because the target product of interest 218 is associated with the manufacturer “Campbell's,” then the ROC grouping 206 includes items associated with manufacturers exclusive of “Campbell's,” which is shown in the illustrated example of FIG. 2 as Progresso 208 and Pacific Foods of Oregon 210. By segregating available historical category data by competitor grouping levels, model efforts may better identify whether significant competitive effects are caused by other manufacturers, within the same manufacturer as the target product of interest and/or variants within the same brand as the target product of interest.

However, examples disclosed herein do not limit competitive influences on the target product of interest 218 to only those items that are made and/or otherwise sourced from different manufacturers. The example ROM identifier 122 identifies a rest-of-manufacturer grouping 212, which includes all items in (a) the soup category (b) that are associated with the same manufacturer as the target product of interest 218 and (c) exclusive of items/products associated with the same brand as the target product of interest 204. Products matching these qualifiers are tagged as ROM products, and will be analyzed in connection with competitive measures of distribution, value on promotion, regular price and promoted price index, as described in further detail below. Because the brand associated with the target product of interest 218 is “Campbell's Chunky,” then the items identified by the ROM identifier 122 include brands from the Campbell's manufacturer that are exclusive (do not include) the brand “Campbell's Chunky.” As shown in the illustrated example of FIG. 2, the ROM identifier 122 has identified items associated with the brand “Harvest Select” 214 and the brand “Healthy Request” 216. Additionally, the products identified by the ROM identifier 122 (see dashed enclosure 212) are mutually exclusive of those products identified by the ROC identifier 120 (see dashed enclosure 206).

The example ROB identifier 124 identifies a rest-of-brand grouping 216, which includes all items in the soup category associated with the same manufacturer and brand, but includes alternate features of the target product of interest 218, such as alternate sizes, alternate flavors, etc. Products matching these qualifiers are tagged as ROB products, and will be analyzed in connection with competitive measures of distribution, value on promotion, regular price and promoted price index, as described in further detail below. In the illustrated example of FIG. 2, the competitive category grouping framework 200 includes three separate classification groupings of ROC 206, ROM 212 and ROB 216, each mutually exclusive to each other with the totality of all three covering all of the potential items within the category that could exhibit an influence on the target product of interest 218.

The example base model engine 112 builds a base model that utilizes data associated with the items from the category data sources 106 that have been classified within the example ROC grouping 206, the example ROM grouping 212 and the example ROB grouping 216. In particular, the example base modeling engine 112 generates a base lift model in a manner consistent with example Equation 1.

$${BL}_{i} = ( \frac{{CompTerm}_{i}^{s}}{{CompTerm}_{i}^{o}} ) * {RPTerm}_{i} * {τ}_{i} \qquad Equation 1$$

In the illustrated example of Equation 1, BLᵢ represents a base lift calculation for a target item i of interest and CompTerm^{O} and CompTerm^{S} represent competitive modeling terms for base and simulated scenarios, respectively. Generally speaking, the base scenarios reflect the historical data being multiplied by coefficients to get a predicted sales value. On the other hand, the simulated scenarios reflect “what if” considerations by, for example, the analyst. The analyst may, for example, wonder what a predicted sales of a target item would be if a promotion of 50% occurred in July of a subsequent year. The example competitive modeling terms (CompTerm) include measures of (a) distribution, (b) value on promotion (VOP), (c) regular price and (d) promoted price index (PPI), as described in further detail below. RPTermⁱ represents regular-price effects caused by triggers under the control of the manufacturer (e.g., promotions, sometimes referred to as “own-effects” or “due-to”), and τᵢ represents a trend term of a dollar value sold of all other items indexed to a time based (e.g., weekly) average.

Four example competitive measures of (a) distribution, (b) VOP, (c) regular price and (d) PPI are computed for the example competitor grouping levels of ROC, ROM and ROB. As shown in example Equation 2, example competitive modeling terms (CompTerm) are computed for the four competitive measures.

$${CompTerm}_{i} = {\prod }_{g} {( \frac{{UPCS}_{i , g}^{s}}{{UPCS}_{i , g}^{o}} )}^{{γ}_{i , g}} * {\prod }_{g} {( \frac{{VOP}_{i , g}^{s}}{{VOP}_{i , g}^{o}} )}^{{ɛ}_{i , g}} * {\prod }_{g} {( \frac{{ln ( RPRV )}_{i , g}^{s}}{{ln ( RPRV )}_{i , g}^{o}} )}^{{θ}_{i , g}} * {\prod }_{g} \{ {( \frac{{VOP}_{i , g , k}^{s}}{{VOP}_{i , g , k}^{o}} )}^{{ɛ}_{i , g , k}} * {( \frac{{ln ( PPI )}_{i , g , k}^{s}}{{ln ( PPI )}_{i , g , k}^{o}} )}^{{ϑ}_{i , g , k}} \} \qquad Equation 2$$

In the illustrated example of Equation 2, g represents a particular competitive group of interest (e.g., ROC, ROM, ROB), γ represents a promoted price elasticity, ε represents a dollar value on promotion lift estimate, θ represents a regular price ratio elasticity, Θ represents a promotional price index elasticity, UPCS represents universal product codes, VOP represents value on promotion, RPRV represents regular price ratio, and PPI represents promoted price index. While the example base model represented in Equation 2 reflects influences from distribution, value on promotion, regular price and promoted price ratios, items/products from the example historical data may not necessarily include influences from those competitive terms. If not, examples disclosed herein eliminate superfluous model terms from wasteful participation in modeling analysis. Additionally, when performing one or more simulations, such competitive term influences may be applied or not applied based on analyst preferences to identify a corresponding category effect/affect.

The example competitive surrogate engine 126 estimates the base model in view of the historical pricing and merchandising activity exhibited by items within the category and considers benchmark scenarios and simulated scenarios of the one or more surrogate terms. Terms for which a product manager, product manufacturer and/or other entity chartered with a responsibility of promoting the target product of interest include promotion via a display only condition (e.g., an in-store display), promotion via a feature only condition (e.g., modified product packaging to highlight one or more particular features of the product), promotion via a combination of display and feature, promotion via special packaging modifications (e.g., bonus pack), promotion via temporary price reduction (TPR), etc.

The example competitive distribution engine 130 identifies competitive distribution surrogate terms to be added to the model that are unique to each competitor grouping level of ROC, ROM and ROB. A measure of distribution for a category is one way a particular item, brand, and/or manufacturer can influence the sales of a target item, and is quantified by UPC count values in a manner consistent with example Equations 3, 4 and 5.

ROCUPCSᵢ^{O}Σ=UPCCountᵢ^{O}−ΣUPCCount_{i=MFG}^{O} Equation 3.

In the illustrated example of Equation 3, i=MFG represents products/items from the example ROM grouping (e.g., the ROM grouping 212 of FIG. 2).

ROMUPCSᵢ^{O}Σ=UPCCount_{i=MFG}^{O}−ΣUPCCount_{i=BRD}^{O} Equation 4.

In the illustrated example of Equation 4, i=BRD represents products/items from the example ROB grouping (e.g., the ROB grouping 216 of FIG. 2).

ROBUPCsᵢ^{O}Σ=UPCCount_{i=BRD}^{O}−ΣUPCCount_{i=TargetUPC}^{O} Equation 5.

In the illustrated example of Equation 5, i=TargetUPC represents the target product of interest to be analyzed in view of the historical market data. While example Equations 3-5 illustrate baseline or benchmark scenarios, similar analysis may occur for simulated scenarios. Note the superscript O denotes the base case and could similarly have denoted S for the proposed iteration of the simulation.

In addition to competitive surrogate terms associated with distribution behavior(s), the example competitive promotion engine 134 defines competitive promotion surrogate terms for each competitor grouping level, reflecting the magnitude of competitive promotional activity. In some examples, the competitive promotion surrogate terms facilitate calculating promotional values and promotional units based on category total units sold, baseline units sold, incremental units and promotional units. The magnitude of promotional activity is referred to as value-on-promotion (VOP), and may be at least one aspect of the competitive modeling terms of example Equations 1 and 2. In the illustrated example of Equation 6 below, the magnitude of promotional activity (PromoVal) is a function of promoted prices of items (PP), total sales units (TotalSalesUnits for baseline and simulated), total baseline units (BU) and a measure of promotional intensity (INT), such as a frequency of a promotional condition. For example, an intensity value (INT) for a promotional display condition indicates that the display condition has been run (or will be run if this is to be used as a simulation) in 5% of the stores contained in the study. Thus, the example competitive promotion engine 134 assigns corresponding surrogate terms (e.g., INT) to only those items that exhibit the behaviors observed in the historical data or are to be simulated.

$$\begin{matrix}{PromoVal}_{ik}^{s} = {PP}_{ik} ( ( {TotalSalesUnits}_{i}^{o} - ( {BU}_{i}^{o} * ( 1 - \sum k ( {INT}_{ik}^{o} ) ) ) ) * {INT}_{kScaled} ) + ( ( {PromoUnits}_{ik}^{s} - {PromoUnits}_{ik}^{o } ) * ( \frac{{INT}_{ik}^{s} - {INT}_{ik}^{o}}{{\sum }_{k} ( {INT}_{ik}^{s} - {INT}_{ik}^{o}} ) ) . \\ where , & Equation 6 \\ {PromoVal}_{ik}^{o} = {PP}_{ik} * {PromoUnits}_{ik}^{o} . & Equation 7 \\ {PromoUnits}_{ik}^{o} = {TotalSalesUnits}_{i}^{o} - {BUNoPromoUnits}_{ik}^{o} . & Equation 8 \\ {BUNoPromoUnits}_{i}^{o} = {BaseUnits}_{i}^{o} * ( 1 - {\sum }_{k} ( {INT}_{ik}^{o} ) ) . & Equation 9\end{matrix}$$

Now that PromoVal can be defined in terms of total sales units, baseline units, promotional sales units and a degree of promotional intensity (INT), competitive surrogate terms for the value on promotion (VOP) may be generated by the competitive promotion engine 134 for each competitor grouping level (e.g., ROC, ROM and ROB). In particular, the competitive promotion engine 134 generates example competitive surrogate terms of Table 1, in which mathematical definitions are illustrated in Appendix A.

TABLE 1

| Competitive | |
|---|---|
| Surrogate Term | Description |
| ROCVOP | Dollar value on promotion for |
| | ROC (category less manufacturer |
| | of target item) |
| CDI | Dollar value on display only for |
| | ROC (category less manufacturer |
| | of target item) |
| CFE | Dollar value on feature only for |
| | ROC (category less manufacturer |
| | of target item) |
| CFD | Dollar value on feature and |
| | display combination for ROC |
| | (category less manufacturer of |
| | target item) |
| ROMVOP | Dollar value on promotion for |
| | ROM (manufacturer less brand of |
| | target item) |
| MDI | Dollar value on display only for |
| | ROM (manufacturer less brand of |
| | target item) |
| MFE | Dollar value on feature only for |
| | ROM (manufacturer less brand of |
| | target item) |
| MFD | Dollar value on feature and |
| | display combination for ROM |
| | (manufacturer less brand of target |
| | item) |
| ROBVOP | Dollar value on promotion for |
| | ROB (brand less the target item) |
| BDI | Dollar value on display only for |
| | ROB (brand less the target item) |
| BFE | Dollar value on feature only for |
| | ROB (brand less the target item) |
| BFD | Dollar value on feature and |
| | display combination for ROB |
| | (brand less the target item) |

In operation, the example competitive promotion engine 134 computes the surrogate terms from the example historical category data. In the event that a particular competitive item did not participate in display only promotional activity (e.g., surrogate variables associated with CDI, MDI and/or BDI), then the example competitive promotion engine 134 would exclude this item from the calculation of CDI, MDI, BDI thereby improving and/or otherwise increasing model specification efficiency and accuracy of the resulting model parameter estimates.

As described above in connection with example Equation 2, the competitive modeling term, CompTerm, is a function of four (4) competitive measures (distribution, magnitude of promotion, regular price, and promoted price), each including one or more surrogate terms that are represented during the model specification process only if they actually exhibit some influence in the example historical category data. In addition to competitive measures of distribution and value on promotion described above, the example competitive promotion engine 134 also calculates regular price competitive and promotional price indices measures for each of the three grouping levels ROC, ROM and ROB.

Regular or base prices for items, denote the shelf price of an item within a store. Regular price typically changes less frequently than promoted price for an item, but has its own unique influence on sales and is estimated separately within the predictive model. Additionally, regular price ratios may be calculated by the example competitive price engine 132 to reflect a weighted measure of the change in relative regular price. Rather than reliance upon analyst discretion regarding which items may or may not exhibit a regular price value influence, one or more surrogate terms are generated by the example competitive price engine 132 and associated with each of the three example grouping levels (ROC, ROM ROB) that, in the aggregate, consider all available competitive items that may influence a target item of interest. Example surrogate terms associated with regular price are shown in the illustrated example of Appendix B.

In addition to competitive surrogate terms associated with distribution behavior(s), competitive promotion behavior(s), and regular price behavior(s), as described above, the example competitive surrogate engine computes promotional price index (PPI) competitive terms for each grouping level. The example PPI terms are weighted measures across the competitive grouping level hierarchy (e.g., ROC, ROM, ROB) that represent a degree of price discounting from regular price. In other words, the PPI is the weighted average promotional price divided by the weighted base price for a particular competitive group, and shown in further detail in Appendix C.

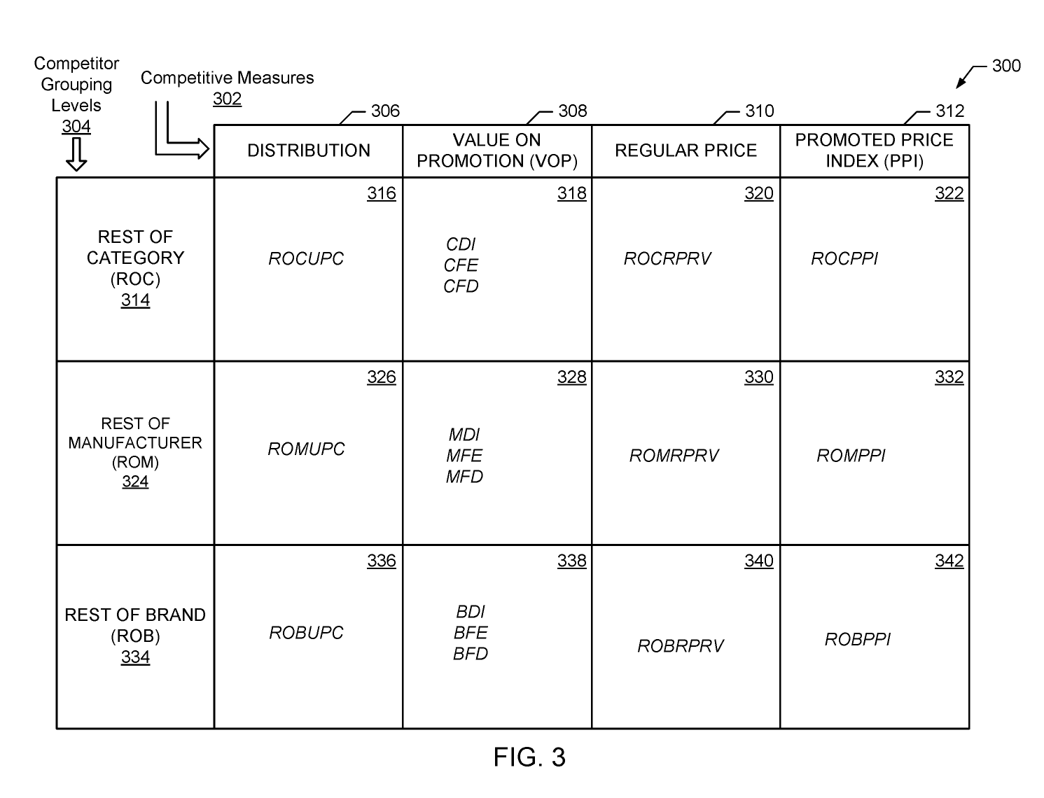

As described above, the example competitive surrogate engine 126 tailors the base model in view of (a) the historical category data (b) that is categorized by corresponding competitive grouping levels (ROC, ROM, ROB) (c) to account for items that could potentially be relevant as described by the distribution, promotional activity, regular prices and promoted prices of the items). To illustrate, FIG. 3 includes an example model hierarchy matrix 300 to specify and/or otherwise tailor a base model to evaluate the historical category data in a manner that (a) includes all potential competitive influences on a target product of interest and (b) does so in a way that increases the efficiency and accuracy of the overall modeling process.

In the illustrated example of FIG. 3, the competitive modeling matrix 300 includes a competitive measures row 302 to identify four (4) competitive measures of (1) distribution, (2) value on promotion, (3) regular price and (4) promoted price index. As described above, distribution 306 is a competitive measure that relates to a quantity (e.g., count of UPCs) of products in the marketplace. In the event that new products are added to a category, it is expected that the sales of the target item of interest may decrease. Additionally, value on promotion (VOP) 308 is a competitive measure that relates to a magnitude of promotional activity. The VOP measure is considered for all types of promotions, such as those having a feature only, those having a display only, those having both a feature and display, and those having a temporary price reduction (TPR). In the event a competitor increases VOP activity, it is expected that the sales of the target item of interest would decrease. Additionally, regular price 310 is a competitive measure that relates to a weighted measure of the change in relative regular price. When a ratio of regular price for a target item to a competitive item increases, it is expected that the sales of the target item would decrease. Additionally, the promoted-price-index (PPI) 312 is a competitive measure that represents a level of price discounting. In the event of a PPI (promotional price divided by a weighted average base price) decrease for the target item of interest, the sales of the target item of interest are expected to decrease.

The example model hierarchy matrix 300 also includes a competitor grouping level column 304 to identify three (3) competitor grouping levels of (1) rest-of-category, (2) rest-of-manufacturer and (3) rest-of-brand. As described above in connection with FIG. 2, to prevent erroneous over-inclusion or under-inclusion of relevant relationships to the predictive modeling process, the competitor grouping engine 118 classifies competitive grouping levels of the historical category data. The example rest-of-category (ROC) competitor grouping level 206 includes products from the historical sales data that have a manufacturer that is different from that of the target product of interest under evaluation. Returning to FIG. 3, the example competitive surrogate engine 126 generates an ROC row 314 in the example model hierarchy matrix 300 to associate those representative products with corresponding competitive measures of distribution (cell 316), VOP (cell 318), regular price (cell 320) and PPI (cell 322).

In operation, the example competitive surrogate engine 126 generates competitive surrogate terms (e.g., ROCUPC,) for the ROC grouping level (cell 316) for each item that includes distribution activity data, such as a count of UPCs for each item (i). Distribution activity data may be identified by the competitive surrogate engine 126 by parsing available historical sales data for each product. VOP data may be identified by parsing promotional fields of the historical market data to identify tags indicative of promotional activity types. As described above, display-only promotional types may be identified with a flag “DISO,” feature-only promotional types may be identified with a flag “FEAO,” combined feature and display promotional types may be identified with a flag “FEDI,” and special pack activity may be identified with a flag “SP,” which may refer to instances of bonus packs, trial packs, etc. Corresponding VOP surrogate terms are then inserted into the model by the competitive surrogate engine 126, such as CDI to represent a dollar value related to display only promotional activity, CFE to represent a dollar value related to feature only promotional activity, and CFD to represent a dollar value related to combined feature and display promotional activity. In some examples, additional and/or alternative terms may be added to the model in view of additional and/or alternative types of promotional activity.

Regular price data is identified by the example competitive surrogate engine 126 by parsing regular price fields of the historical market data, and corresponding regular price surrogate terms are then generated by the competitive surrogate engine 126 and inserted into the model. Example regular price surrogate terms include ROCRPRV, as shown in cell 320 and defined in Appendix B.

PPI data is identified by the example competitive surrogate engine 126 by parsing promotional price fields of the historical market data and, if promotional price data is present, then the corresponding item and surrogate terms may be added to the model. Example PPI surrogate terms include ROCPPI, as shown in cell 322 and defined in Appendix C.

Additionally, and as described above in connection with FIG. 2, the competitor grouping engine 118 classifies competitive grouping levels of the historical market data for a rest-of-manufacturer (ROM) competitor grouping level 212. In particular, the ROM grouping level includes products from the historical sales data that have the same manufacturer as the target brand of interest, but also have a brand that is dissimilar to the target product of interest. Returning to FIG. 3, the example competitive surrogate engine 126 generates an ROM row 324 in the example hierarchy matrix 300 to associate those representative products with corresponding competitive measures of distribution (cell 326), VOP (cell 328), regular price (cell 330) and PPI (cell 322). Corresponding competitive measure surrogate terms for the ROM grouping level are also identified by the example surrogate engine 126 by parsing the available historical market data, as described above.

Additionally, and as described above in connection with FIG. 2, the competitor grouping engine 118 classifies competitive grouping levels of the historical market data for a rest-of-brand (ROB) competitor grouping level 216. In particular, the ROB grouping level includes products from the historical sales data that have the same brand as the target product of interest, but different features of the target product of interest. Returning to FIG. 3, the example competitive surrogate engine 126 generates an ROB row 334 in the example hierarchy matrix 300 to associate those representative products with corresponding competitive measures of distribution (cell 336), VOP (cell 338), regular price (cell 340) and PPI (cell 342). Corresponding competitive measure surrogate terms for the ROB grouping level are also identified by the example surrogate engine 126 by parsing the available historical market data, as described above.

Unlike traditional regression models that evaluate any and all variables selected by analyst discretion, examples disclosed above categorize all available products from historical category data into component levels. That is, examples disclosed above develop and/or otherwise reveal a hierarchy of the historical category data into levels of rest-of-category (ROC), rest-of-manufacturer (ROM), and rest-of-brand (ROB). In the aggregate, each of the three aforementioned levels includes any and all products that may exhibit any influence on a target product of interest, which prevents erroneous under-inclusion of items that should be considered as competition to a target product of interest. Mis-specification of the predictive model leads to mis-representing the true relationship between competitors pricing and merchandising activity and the sales response of the target item of interest. Proper specification of the predictive model ensures more efficient use of both computational and analytical resources in providing insights on historical pricing and merchandising tactics within the category.

With the base model defined via the example model hierarchy matrix 300 of FIG. 3 to identify (a) items to evaluate and (b) the corresponding surrogate variables, the example base model engine 112 evaluates the model to derive coefficient values for the surrogate variables. In some examples, the model integrity rules manager 114 analyzes the derived coefficient values to determine compliance with one or more model business rules. For example, a convergence test may be executed by the integrity rules manager 114 to identify one or more aspects of the model that exhibit results that fail to comply with expected statistical outcomes. In some examples, business rules dictate that coefficient lift results for promotions (e.g., Display, Feature, and Feature and Display) intuitive and/or otherwise consistent with typical market expectations (e.g., positive effects in response to one or more promotions). Likewise, price elasticity terms typically exhibit a negative relationship with sales. In still other examples, the model integrity rules manager 114 may identify that the model has been over-parameterized, which can result in a lack of convergence or one or more spurious correlations between terms. When such model anomalies are detected by the example model integrity rules manager 114, one or more iterations of model evaluation may proceed after removing a potential reason for the lack of convergence.

While an example manner of implementing the category structure market system 100 of FIG. 1 is illustrated in FIG. 1, one or more of the elements, processes and/or devices illustrated in FIG. 1 may be combined, divided, re-arranged, omitted, eliminated and/or implemented in any other way. Further, the example category data interface 108, the example target engine 110, the example base model engine 112, the example model integrity rules manager 114, the example rules storage 116, the example competitor grouping engine 118, the example ROC identifier 120, the example ROM identifier 122, the example ROB identifier 124, the example competitive surrogate engine 126, the example competitive distribution engine 130, the example competitive price engine 132, the example competitive promotion engine 134 and/or, more generally, the example non-named competitors (NNC) engine 102 of FIG. 1 may be implemented by hardware, software, firmware and/or any combination of hardware, software and/or firmware. Thus, for example, any of the example category data interface 108, the example target engine 110, the example base model engine 112, the example model integrity rules manager 114, the example rules storage 116, the example competitor grouping engine 118, the example ROC identifier 120, the example ROM identifier 122, the example ROB identifier 124, the example competitive surrogate engine 126, the example competitive distribution engine 130, the example competitive price engine 132, the example competitive promotion engine 134 and/or, more generally, the example non-named competitors (NNC) engine 102 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example category data interface 108, the example target engine 110, the example base model engine 112, the example model integrity rules manager 114, the example rules storage 116, the example competitor grouping engine 118, the example ROC identifier 120, the example ROM identifier 122, the example ROB identifier 124, the example competitive surrogate engine 126, the example competitive distribution engine 130, the example competitive price engine 132, the example competitive promotion engine 134 and/or, more generally, the example NNC engine 102 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example NNC engine 102 of FIG. 1 may include one or more elements, processes and/or devices in addition to, or instead of, those illustrated in FIG. 1, and/or may include more than one of any or all of the illustrated elements, processes and devices.

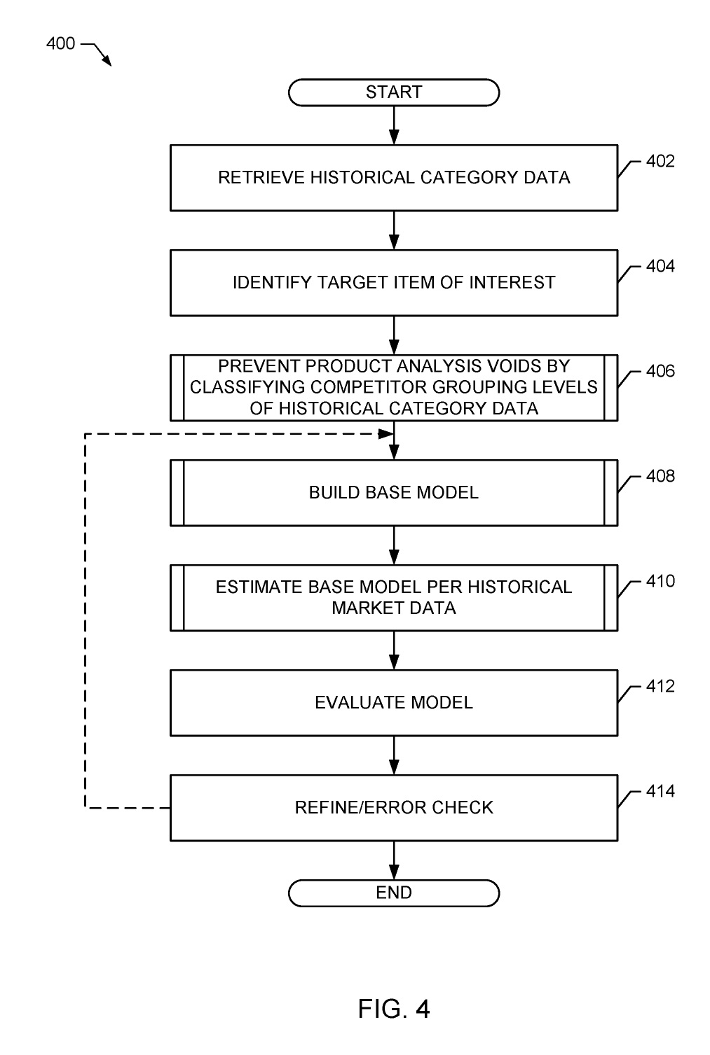

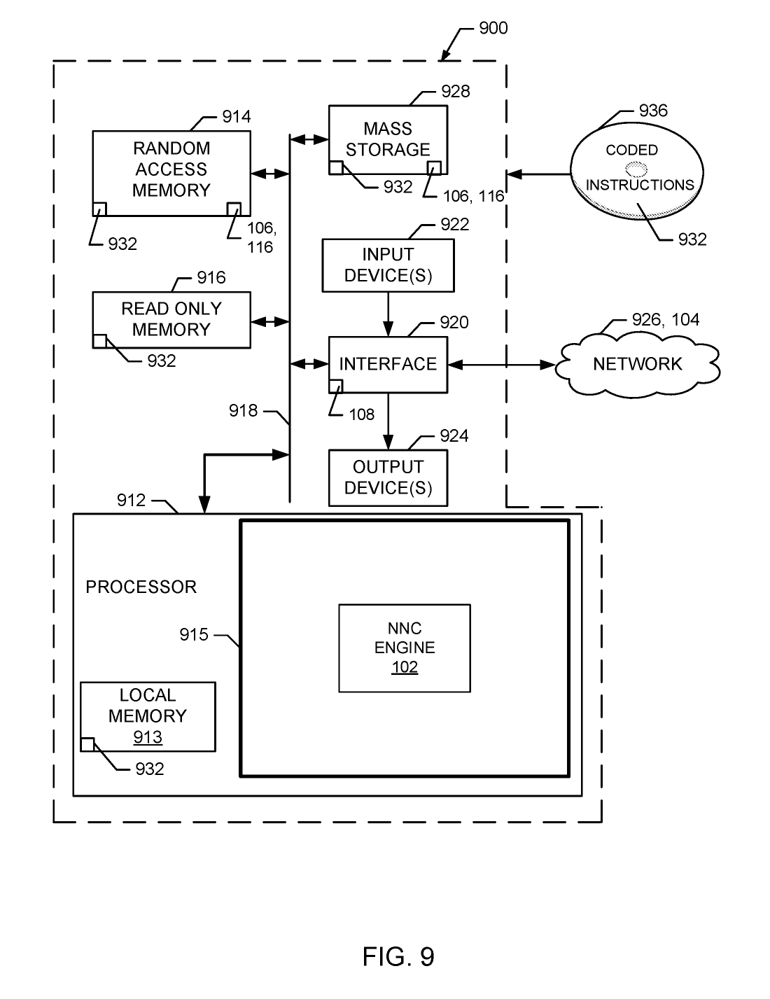

Flowcharts representative of example machine readable instructions for implementing the NNC engine 102 of FIG. 1 are shown in FIGS. 4-8. In these examples, the machine readable instructions comprise a program for execution by a processor such as the processor 912 shown in the example processor platform 900 discussed below in connection with FIG. 9. The program may be embodied in software stored on a tangible computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or dedicated hardware. Further, although the example programs are described with reference to the flowchart illustrated in FIGS. 4-8, many other methods of implementing the example NNC engine 102 may alternatively be used. For example, the order of execution of the blocks may be changed, and/or some of the blocks described may be changed, eliminated, or combined.

As mentioned above, the example processes of FIGS. 4-8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4-8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 400 of FIG. 4 begins at block 402, where the example category data interface 108 retrieves and/or otherwise receives historical category data from the example market data sources 106. Model evaluation occurs in view of a target item of interest, which is identified and/or otherwise provided to the target engine 110 (e.g., via analyst request) (block 404). The example competitor grouping engine 118 prevents product analysis voids typically due to analyst discretion by classifying competitor grouping levels of the historical category data (block 406).

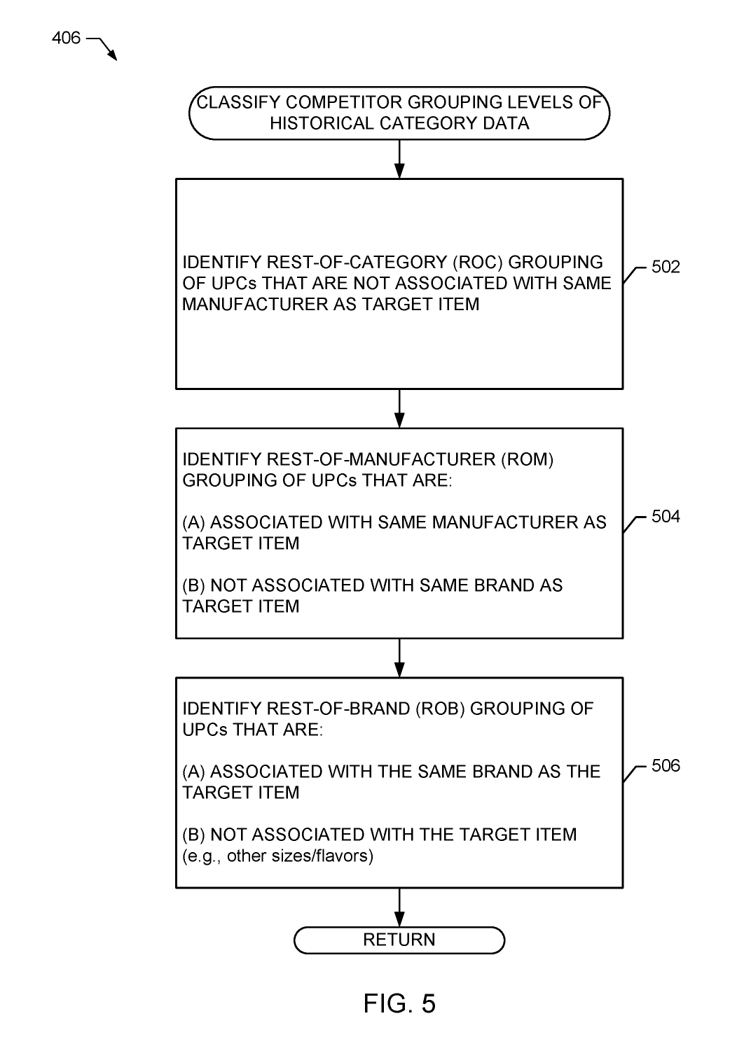

Turning briefly to FIG. 5, the example ROC identifier 120 determines which of the products from the historical category data are not associated with the same manufacturer as the target item (block 502). Traditionally, analyst identification of “competitive” products only included those by competing manufacturers, which fail to illustrate a complete understanding of category effects in the event the target product of interest is seeded with one or more simulated competitive measures (e.g., an increased distribution, increased VOP, a change in regular price value, and/or promoted price, etc.). As described above and shown in the illustrated example of FIG. 2, those products that are not associated with the same manufacturer as the target item are identified as ROC products 206, while the remaining products waterfall to either ROM products 212 or ROB products 216.

Returning to FIG. 5, the example ROM identifier 122 determines which of the remaining products from the historical category data are contained within the same manufacturer as the target item, but not associated with the same brand as the target item (block 504). Again, turning briefly to the illustrated example of FIG. 2, those products that are not associated with the same brand as the target item, but are the same manufacturer as the target item, are identified as ROM products 212, while the remaining products waterfall to ROB products 216.

Returning again to FIG. 5, the example ROB identifier 124 determines which of the remaining products from the historical category data are (a) the target item of interest and (b) other products of the same brand as the target item of interest, yet have alternate parameters (e.g., alternate sizes, alternate flavors, alternate colors, alternate packaging quantities, etc.) (block 506). Turning briefly to the illustrated example of FIG. 2, those products that are associated with the same brand, but having alternate parameters as the target item are identified as ROB products 216.

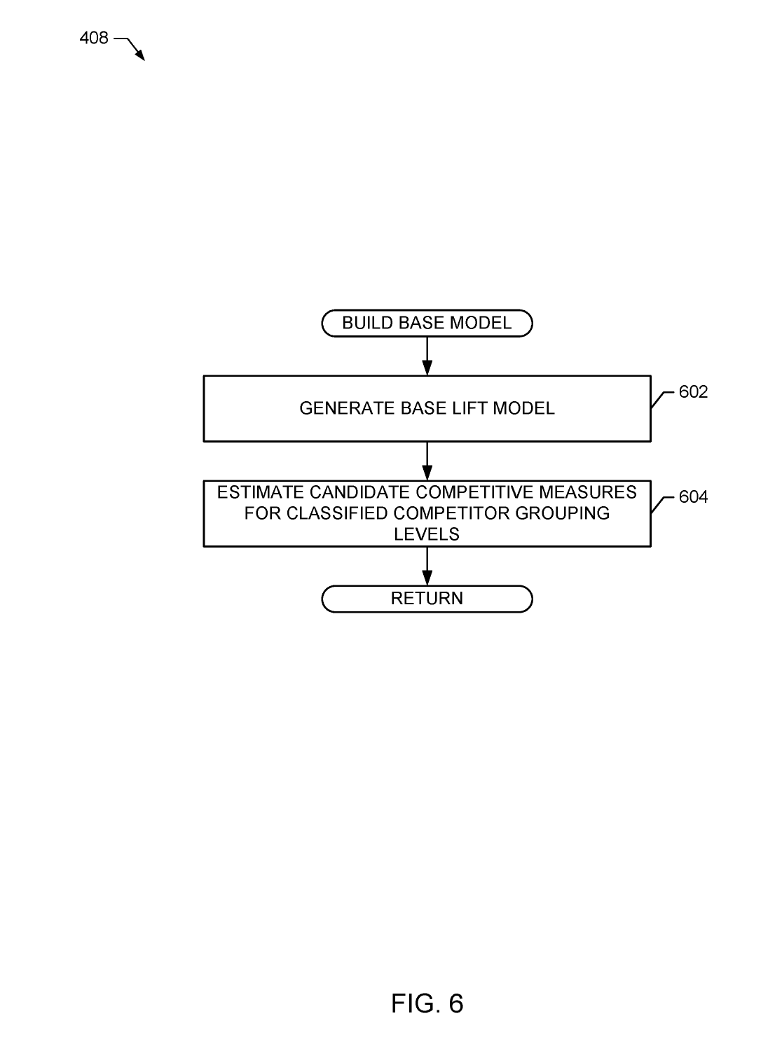

Returning to FIG. 4, the example base model engine 112 builds a base model (block 408). Generally speaking, the base model may be performed one time unless convergence does not occur, as described in further detail below. Turning to FIG. 6, the example base model engine 112 generates a base lift model in a manner consistent with example Equation 1 (block 602). Aspects of the competitive modeling terms manifest themselves as competitive measures of distribution, value-on-promotion, regular price and promoted price index. The example base model engine 112 estimates candidate competitive measures for each classified competitor grouping level (e.g., ROC, ROM, ROB) in a manner consistent with example Equation 2 (block 604).

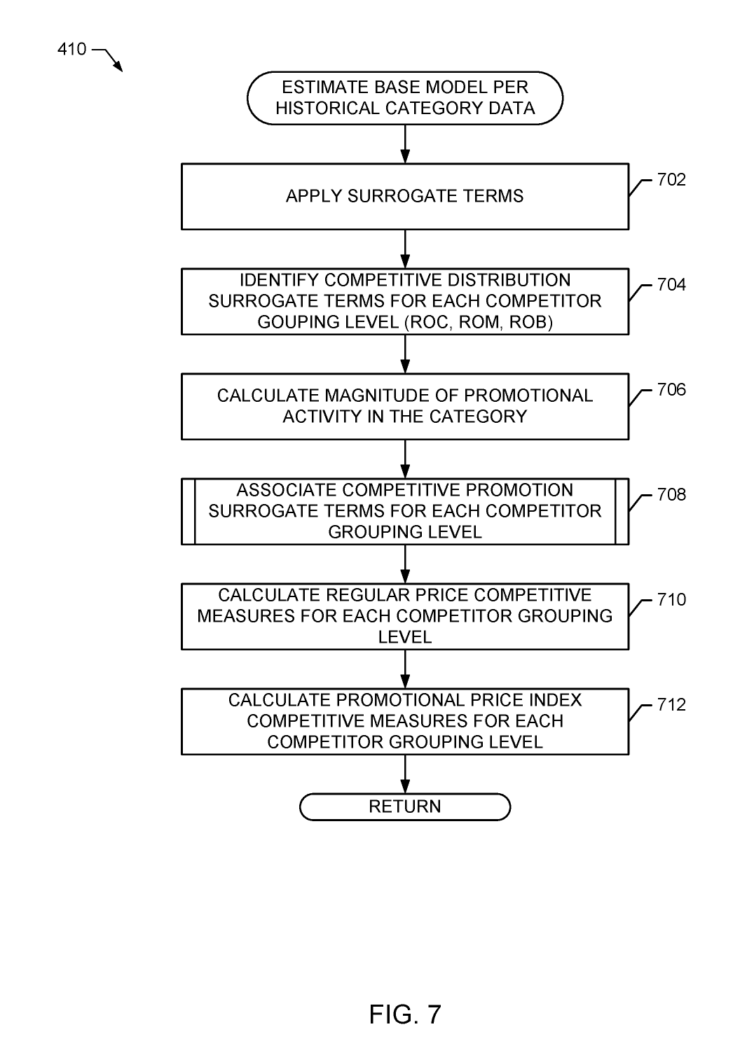

FIG. 7 illustrates additional detail related to utilizing the base model in view of historical category data (block 410). In the illustrated example of FIG. 7, the competitor grouping engine 118 utilizes and/or otherwise applies surrogate terms in the model (block 702). Generally speaking, an analyst may consider any number of merchandizing plans or candidate campaigns for the target product, such as an additional period of time to extend a currently running promotion. More specifically, the analyst may be interested in knowing how this particular candidate campaign will affect the whole category (e.g., a soup category), or how this candidate campaign will affect the other brands that share a similar manufacturer (e.g., how does the candidate campaign affect the “chunky soup” brand versus the “healthy starts” brand). In other examples, the analyst may know that several new products are about to enter the market and wants to know how that might affect one or more aspects of the brand or category. Based on the desired simulation strategy, all historical data is considered to compute the surrogate variables associated with the target item in the model, such as the example competitive surrogate term “CFD” and associated magnitude values to reflect a simulated dollar value on a promotion that includes both a feature and a display. In the event some competitive items do not exhibit price change and/or promotional activity, then associated surrogate terms do not impart an influence (or a correspondingly small influence). Similarly, proportional differences between different competitive items will impart proportional influences when such competitive items from the historical data exhibit particular price changes and/or promotional activity.

The example competitive distribution engine 130 identifies competitive distribution surrogate terms for each competitor grouping level (e.g., ROC, ROM, ROB) that have non-zero values in the historical category data (block 704). To the extent that one or more items (products) from the historical category data exhibit distribution-related activity, such influences are added to the model as shown by the example model hierarchy matrix 300. More specifically, distribution-related activities are added to the model with surrogate terms unique to whether the associated items are within the (a) ROC level (see cell 316 of FIG. 3), (b) ROM level (see cell 326 of FIG. 3) or (c) ROB level (see cell 336 of FIG. 3).

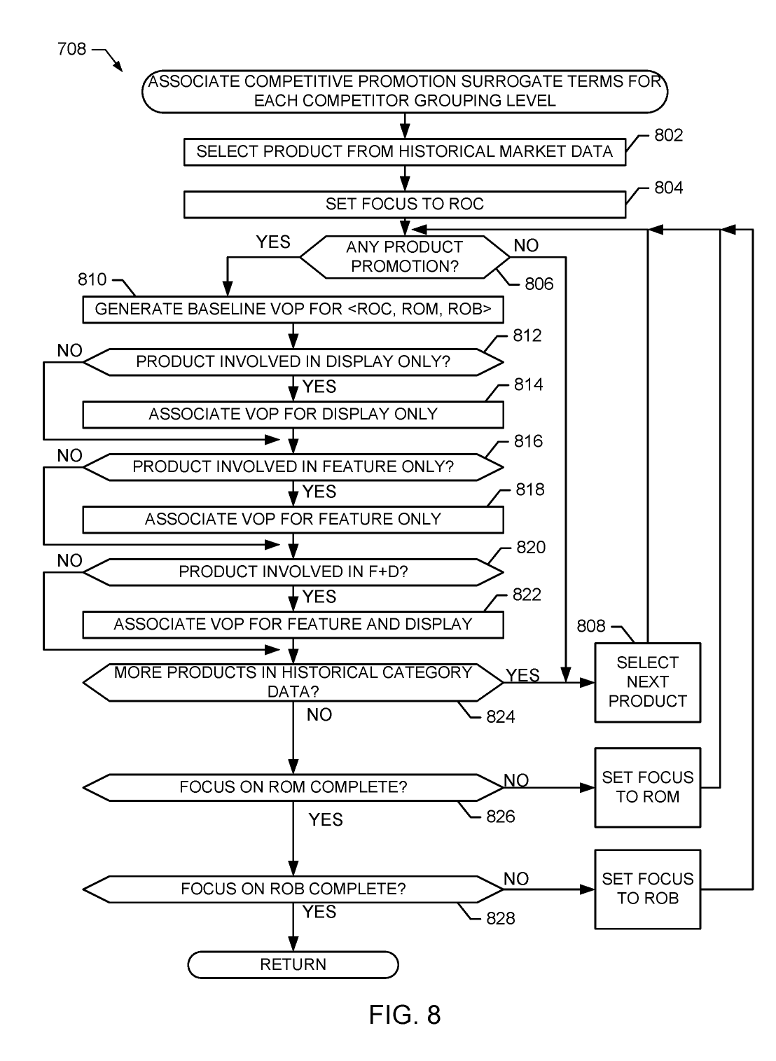

The example competitive promotion engine 134 calculates a magnitude of promotional activity in the category in a manner consistent with example Equations 6-9 (block 706), which serve as a basis for determining one or more competitive promotion surrogate terms. The example competitive promotion engine 134 defines particular competitive promotion surrogate terms to be associated with respective competitor grouping levels based on the historical market data (block 708). FIG. 8 illustrates additional detail of block 708, in which the example competitive promotion engine 134 selects a candidate product/item from the historical market data (block 802) in connection with products categorized as ROC (block 804). The data associated with the selected product/item is analyzed by the competitive promotion engine 134 to identify one or more promotional indicators, such as a display-only promotion, a feature-only promotion, a combined feature and display promotion, etc. If the competitive promotion engine 134 determines that the selected product was not involved in any promotional activity (block 806), then the example competitive promotion engine 134, then the corresponding surrogate terms to not affect and/or otherwise influence the estimation of the model This, in turn, prevents over-parameterization of the model. In some examples disclosed herein, under-parameterization is addressed in circumstances when an analyst includes products that compete, yet those products have little or no promotional activity. In such circumstances, a subsequent iteration of the model can be executed after identifying this occurrence such that those particular competitive products are removed from model evaluation. The example competitive promotion engine 134 then selects a next available product to evaluate (block 808). However, if the selected product has associated promotional activity, then the example competitive promotion engine 134 generates and/or otherwise applies a respective surrogate term for the rest-of-category VOP (ROCVOP) (block 810).

The example competitive promotion engine 134 determines whether the selected product has any promotional activity associated with display-only (block 812), such as by parsing a tag or flag associated with display-only promotional activity (e.g., “DISO,” etc.). As described above, the example historical market data may include information related to promotional activity, a type of promotional activity (e.g., display, feature, feature plus display, etc.) and/or an amount of promotional activity (e.g., a percentage discount amount, a dollar value discount amount, a TPR amount, etc.). If so, then the example competitive promotion engine 134 generates, assocaites and/or otherwise applies a surrogate term for a dollar value on display-only for the rest-of-category VOP (CDI) (block 814), which is also defined in Appendix A. However, if the selected product does not have any display-only promotional activity (block 812), corresponding surrogate values do not influence the model, or do so on a proportional basis, and then the example competitive promotion engine 134 determines whether the selected product has any promotional activity associated with feature-only (block 816), such as by parsing a tag or flag associated with feature-only promotional activity (e.g., “FEAO,” etc.). If so, then the example competitive promotion engine 134 generates, associates and/or otherwise applies a surrogate term for a dollar value on feature-only for the rest-of-category VOP (CFE) (block 818), which is also defined in Appendix A.

If the selected product does not have any feature-only promotional activity (block 816), corresponding surrogate values do not influence the model, or do so on a proportional basis, and then the example competitive promotion engine 134 determines whether the selected product has any promotional activity associated with feature and display (block 820), such as by parsing a tag or flag associated with feature-and-display promotional activity (e.g., “FEDI,” etc.). If so, then the example competitive promotion engine 134 generates, associates and/or otherwise applies a surrogate term for a dollar value on feature-and-display for the rest-of-category VOP (CFD) (block 822), which is also defined in Appendix A. The example competitive promotion engine 134 determines whether additional products are still to be considered from the historical market data (block 824) and, if so, control returns to block 808 to select a next product of interest from the historical market data that is associated with the rest-of-category VOP. When all products associated with the rest-of-category VOP have been considered, the example competitive promotion engine 134 determines whether the rest-of-manufacturer VOP has been considered (block 826). If not, then the competitive promotion engine 134 repeats the consideration of products within the historical market data that are categorized within the ROM grouping level for promotional conditions similar to those discussed above in view of blocks 806 through 824. Additionally, when all of the ROM grouping level products within the historical market data are considered for the surrogate terms (block 826), the example competitive promotion engine 134 repeats the consideration of products within the historical market data that are categorized within the ROB grouping level for promotional conditions similar to those discussed above in view of blocks 806 through 824 (block 828). Control then returns to block 710 of FIG. 7.

In the illustrated example of FIG. 7, the competitive price engine 132 generates and/or otherwise applies surrogate terms for regular price competitive measures for each competitor grouping level (block 710). As described above, regular price is one of four competitive measures/terms that contributes to the base lift calculation, as shown in Equations 1 and 2, and further defined in Appendix B. The example competitive surrogate engine 126 generates, associates and/or otherwise applies surrogate terms for promotional price index (PPI) competitive measures/terms for each competitor grouping level (block 712). As described above, PPI is another one of the four competitive measures/terms that contribute to the base lift calculations of Equations 1 and 2, which are further defined in Appendix C.

Returning to the illustrated example of FIG. 4, the example base model engine 112 evaluates the model (block 412), which is now optimized to (a) consider items from the historical market data that exhibit an influence on the target product of interest and (b) consider model terms from the model to promote more efficient evaluation. While application of all surrogate values allows the model to be evaluated one time, thereby improving model evaluation efficiency and performance improvements, additional iterations of model evaluation may occur, in which the example model integrity rules manager 114 refines the model and/or otherwise checks for errors (block 414). In some examples, the model integrity rules manager 114 performs one or more convergence tests and/or adjustments to correct for over-parameterization effects.

FIG. 9 is a block diagram of an example processor platform 900 capable of executing the instructions of FIGS. 4-8 to implement the NNC engine 102 of FIG. 1. The processor platform 900 can be, for example, a server, a personal computer, an Internet appliance, a set top box, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer. In the illustrated example of FIG. 9, the processor 912 includes one or more example processing cores 915 configured via example instructions 932, which include the example instructions of FIGS. 4-8 to implement the example NNC engine 102 of FIG. 1.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint, a voice recognition system and/or any other human-machine interface.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIGS. 4-8 may be stored in the mass storage device 928, in the volatile memory 914, in the non-volatile memory 916, and/or on a removable tangible computer readable storage medium such as a CD or DVD.

From the foregoing, it will be appreciated that the above disclosed methods, apparatus and articles of manufacture eliminate and/or reduce an occurrence of modeling errors due to analyst discretion when attempting to identify which competitive products to include in a modeling analysis. Additionally, because available historical market items are analyzed for competitive effect contributions prior to model evaluation, instances of model over-parameterization are reduced by preventing non-relevant items from being included as model terms. Furthermore, computational efficiency of the modeling evaluation is improved when superfluous modeling terms are eliminated during model building efforts.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

$$\begin{matrix} Appendix A & \\ {ROCVOP}_{i}^{O} = ( \sum ( {PromoVal}_{i}^{O} ) - \sum ( {PromoVal}_{i = MFG}^{O} ) ) / ( ( \sum ( {PromoVal}_{i}^{O} ) - \sum ( {PromoVal}_{i = MFG}^{O} ) ) + ( \sum ( {BUNoPromoVal}_{i}^{O} ) - \sum ( {BUNoPromoVal}_{i = MFG}^{O} ) ) ) & ( 3.2 .2 .7 ) \\ {CDI}_{i}^{O} = ( \sum ( {PromoVal}_{{i}_{Display}}^{O} ) - \sum ( {PromoVal}_{i = {MFG}_{Display}}^{O} ) ) / ( \sum ( {PromoVal}_{{i}_{Display}}^{O} ) - \sum ( {PromoVal}_{i = {MFG}_{Display}}^{O} ) ) + ( \sum ( {BUNoPromoVal}_{{i}_{Display}}^{O} ) - \sum ( {BUNoPromoVal}_{i = {MFG}_{Display}}^{O} ) ) & ( 3.2 .2 .7 .1 ) \\ {CFE}_{i}^{O} = ( \sum ( {PromoVal}_{{i}_{Feature}}^{O} ) - \sum ( {PromoVal}_{i = {MFG}_{Feature}}^{O} ) ) / ( \sum ( {PromoVal}_{{i}_{Feature}}^{O} ) - \sum ( {PromoVal}_{i = {MFG}_{Feature}}^{O} ) ) + ( \sum ( {BUNoPromoVal}_{{i}_{Feature}}^{O} ) - \sum ( {BUNoPromoVal}_{i = {MFG}_{Feature}}^{O} ) ) & ( 3.2 .2 .7 .2 ) \\ {CFD}_{i}^{O} = ( \sum ( {PromoVal}_{{i}_{FeatureDisplay}}^{O} ) - \sum ( {PromoVal}_{i = {MFG}_{FeatureDisplay}}^{O} ) ) / ( \sum ( {PromoVal}_{{i}_{FeatureDisplay}}^{O} ) - \sum ( {PromoVal}_{i = {MFG}_{FeatureDisplay}}^{O} ) ) + ( \sum ( {BUNoPromoVal}_{{i}_{FeatureDisplay}}^{O} ) - \sum ( {BUNoPromoVal}_{i = {MFG}_{FeatureDisplay}}^{O} ) ) & ( 3.2 .2 .7 .3 ) \\ {ROCVOP}_{i}^{S} = ( \sum ( {PromoVal}_{i}^{S} ) - \sum ( {PromoVal}_{i = MFG}^{S} ) ) / ( ( \sum ( {PromoVal}_{i}^{S} ) - \sum ( {PromoVal}_{i = MFG}^{S} ) ) + ( \sum ( {BUNoPromoVal}_{i}^{S} ) - \sum ( {BUNoPromoVal}_{i = MFG}^{S} ) ) ) & ( 3.2 .2 .8 ) \\ {CDI}_{i}^{S} = ( \sum ( {PromoVal}_{{i}_{Display}}^{S} ) - \sum ( {PromoVal}_{i = {MFG}_{Display}}^{S} ) ) / ( \sum ( {PromoVal}_{{i}_{Display}}^{S} ) - \sum ( {PromoVal}_{i = {MFG}_{Display}}^{S} ) ) + ( \sum ( {BUNoPromoVal}_{{i}_{Display}}^{S} ) - \sum ( {BUNoPromoVal}_{i = {MFG}_{Display}}^{S} ) ) & ( 3.2 .2 .8 .1 ) \\ {CFE}_{i}^{S} = ( \sum ( {PromoVal}_{{i}_{Feature}}^{S} ) - \sum ( {PromoVal}_{i = {MFG}_{Feature}}^{S} ) ) / ( \sum ( {PromoVal}_{{i}_{Feature}}^{S} ) - \sum ( {PromoVal}_{i = {MFG}_{Feature}}^{S} ) ) + ( \sum ( {BUNoPromoVal}_{{i}_{Feature}}^{S} ) - \sum ( {BUNoPromoVal}_{i = {MFG}_{Feature}}^{S} ) ) & ( 3.2 .2 .8 .2 ) \\ {CFD}_{i}^{S} = ( \sum ( {PromoVal}_{{i}_{FeatureDisplay}}^{S} ) - \sum ( {PromoVal}_{i = {MFG}_{FeatureDisplay}}^{S} ) ) / ( \sum ( {PromoVal}_{{i}_{FeatureDisplay}}^{S} ) - \sum ( {PromoVal}_{i = {MFG}_{FeatureDisplay}}^{S} ) ) + ( \sum ( {BUNoPromoVal}_{{i}_{FeatureDisplay}}^{S} ) - \sum ( {BUNoPromoVal}_{i = {MFG}_{FeatureDisplay}}^{S} ) ) & ( 3.2 .2 .8 .3 ) \\ 〚 ROMOP 〛 \_i \hat{} O = ( \sum ( PromoVal\_ ( i = MFG ) \hat{} O ) - \sum ( PromoVal\_ ( i = BRD ) \hat{} O ) ) / ( ( \sum ( {PromoVal}_{i = MFG}^{O} ) - \sum ( {PromoVal}_{i = BRD}^{O} ) ) + ( \sum ( {BUNoPromoVal}_{i = MFG}^{O} ) - \sum ( {BUNoPromoVal}_{i = BRD}^{O} ) ) ) & ( 3.2 .2 .9 ) \\ {MDI}_{i}^{O} = ( \sum ( {PromoVal}_{i = {MFG}_{Display}}^{O} ) - \sum ( {PromoVal}_{i = {BRD}_{Display}}^{O} ) ) / ( \sum ( {PromoVal}_{i = {MFG}_{Display}}^{O} ) - \sum ( {PromoVal}_{i = {BRD}_{Display}}^{O} ) ) + ( \sum ( {BUNoPromoVal}_{i = {MFG}_{Display}}^{O} ) - \sum ( {BUNoPromoVal}_{i = {BRD}_{Display}}^{O} ) ) & ( 3.2 .2 .9 .1 ) \\ {MFE}_{i}^{O} = ( \sum ( {PromoVal}_{i = {MFG}_{Feature}}^{O} ) - \sum ( {PromoVal}_{i = {BRD}_{Feature}}^{O} ) ) / ( \sum ( {PromoVal}_{i = {MFG}_{Feature}}^{O} ) - \sum ( {PromoVal}_{i = {BRD}_{Feature}}^{O} ) ) + ( \sum ( {BUNoPromoVal}_{i = {MFG}_{Feature}}^{O} ) - \sum ( {BUNoPromoVal}_{i = {BRD}_{Feature}}^{O} ) ) & ( 3.2 .2 .9 .2 ) \\ {MFD}_{i}^{O} = ( \sum ( {PromoVal}_{i = {MFG}_{FeatureDisplay}}^{O} ) - \sum ( {PromoVal}_{i = {BRD}_{FeatureDisplay}}^{O} ) ) / ( \sum ( {PromoVal}_{i = {MFG}_{FeatureDisplay}}^{O} ) - \sum ( {PromoVal}_{i = {BRD}_{FeatureDisplay}}^{O} ) ) + ( \sum ( {BUNoPromoVal}_{i = {MFG}_{FeatureDisplay}}^{O} ) - \sum ( {BUNoPromoVal}_{i = {BRD}_{FeatureDisplay}}^{O} ) ) & ( 3.2 .2 .9 .3 ) \\ {ROMVOP}_{i}^{S} = ( \sum ( {PromoVal}_{i = MFG}^{S} ) - \sum ( {PromoVal}_{i = BRD}^{S} ) ) / ( ( \sum ( {PromoVal}_{i = MFG}^{S} ) - \sum ( {PromoVal}_{i = BRD}^{S} ) ) + ( \sum ( {BUNoPromoVal}_{i = MFG}^{S} ) - \sum ( {BUNoPromoVal}_{i = BRD}^{S} ) ) ) & ( 3.2 .2 .10 ) \\ {MDI}_{i}^{S} = ( \sum ( {PromoVal}_{i = {MFG}_{Display}}^{S} ) - \sum ( {PromoVal}_{i = {BRD}_{Display}}^{S} ) ) / ( \sum ( {PromoVal}_{i = {MFG}_{Display}}^{S} ) - \sum ( {PromoVal}_{i = {BRD}_{Display}}^{S} ) ) + ( \sum ( {BUNoPromoVal}_{i = {MFG}_{Display}}^{S} ) - \sum ( {BUNoPromoVal}_{i = {BRD}_{Display}}^{S} ) ) & ( 3.2 .2 .10 .1 ) \\ {MFE}_{i}^{S} = ( \sum ( {PromoVal}_{i = {MFG}_{Feature}}^{S} ) - \sum ( {PromoVal}_{i = {BRD}_{Feature}}^{S} ) ) / ( \sum ( {PromoVal}_{i = {MFG}_{Feature}}^{S} ) - \sum ( {PromoVal}_{i = {BRD}_{Feature}}^{S} ) ) + ( \sum ( {BUNoPromoVal}_{i = {MFG}_{Feature}}^{S} ) - \sum ( {BUNoPromoVal}_{i = {BRD}_{Feature}}^{S} ) ) & ( 3.2 .2 .10 .2 ) \\ {MFD}_{i}^{S} = ( \sum ( {PromoVal}_{i = {MFG}_{FeatureDisplay}}^{S} ) - \sum ( {PromoVal}_{i = {BRD}_{FeatureDisplay}}^{S} ) ) / ( \sum ( {PromoVal}_{i = {MFG}_{FeatureDisplay}}^{S} ) - \sum ( {PromoVal}_{i = {BRD}_{FeatureDisplay}}^{S} ) ) + ( \sum ( {BUNoPromoVal}_{i = {MFG}_{FeatureDisplay}}^{S} ) - \sum ( {BUNoPromoVal}_{i = {BRD}_{FeatureDisplay}}^{S} ) ) & ( 3.2 .2 .10 .3 ) \\ {ROBVOP}_{i}^{O} = ( \sum ( {PromoVal}_{i = BRD}^{O} ) - \sum ( {PromoVal}_{i = TargetUPC}^{O} ) ) / ( ( \sum ( {PromoVal}_{i = BRD}^{O} ) - \sum ( {PromoVal}_{i = TargetUPC}^{O} ) ) + ( \sum ( {BUNoPromoVal}_{i = BRD}^{O} ) - \sum ( {BUNoPromoVal}_{i = TargetUPC}^{O} ) ) ) & ( 3.2 .2 .11 ) \\ {BDI}_{i}^{O} = ( \sum ( {PromoVal}_{i = {BRD}_{Display}}^{O} ) - \sum ( {PromoVal}_{i = {TargetUPC}_{Display}}^{O} ) ) / ( \sum ( {PromoVal}_{i = {BRD}_{Display}}^{O} ) - \sum ( {PromoVal}_{i = {TargetUPC}_{Display}}^{O} ) ) + ( \sum ( {BUNoPromoVal}_{i = {BRD}_{Display}}^{O} ) - \sum ( {BUNoPromoVal}_{i = {TargetUPC}_{Display}}^{O} ) ) & ( 3.2 .2 .11 .1 ) \\ {BFE}_{i}^{O} = ( \sum ( {PromoVal}_{i = {BRD}_{Feature}}^{O} ) - \sum ( {PromoVal}_{i = {TargetUPC}_{Feature}}^{O} ) ) / ( \sum ( {PromoVal}_{i = {BRD}_{Feature}}^{O} ) - \sum ( {PromoVal}_{i = {TargetUPC}_{Feature}}^{O} ) ) + ( \sum ( {BUNoPromoVal}_{i = {BRD}_{Feature}}^{O} ) - \sum ( {BUNoPromoVal}_{i = {TargetUPC}_{Feature}}^{O} ) ) & ( 3.2 .2 .11 .2 ) \\ {BFD}_{i}^{O} = ( \sum ( {PromoVal}_{i = {BRD}_{FeatureDisplay}}^{O} ) - \sum ( {PromoVal}_{i = {TargetUPC}_{FeatureDisplay}}^{O} ) ) / ( \sum ( {PromoVal}_{i = {BRD}_{FeatureDisplay}}^{O} ) - \sum ( {PromoVal}_{i = {TargetUPC}_{FeatureDisplay}}^{O} ) ) + ( \sum ( {BUNoPromoVal}_{i = {BRD}_{FeatureDisplay}}^{O} ) - \sum ( {BUNoPromoVal}_{i = {TargetUPC}_{FeatureDisplay}}^{O} ) ) & ( 3.2 .2 .11 .3 ) \\ {ROBVOP}_{i}^{S} = ( \sum ( {PromoVal}_{i = BRD}^{S} ) - \sum ( {PromoVal}_{i = TargetUPC}^{S} ) ) / ( ( \sum ( {PromoVal}_{i = BRD}^{S} ) - \sum ( {PromoVal}_{i = TargetUPC}^{S} ) ) + ( \sum ( {BUNoPromoVal}_{i = BRD}^{S} ) - \sum ( {BUNoPromoVal}_{i = TargetUPC}^{S} ) ) ) & ( 3.2 .2 .12 ) \\ {BDI}_{i}^{S} = ( \sum ( {PromoVal}_{i = {BRD}_{Display}}^{S} ) - \sum ( {PromoVal}_{i = {TargetUPC}_{Display}}^{S} ) ) / ( \sum ( {PromoVal}_{i = {BRD}_{Display}}^{S} ) - \sum ( {PromoVal}_{i = {TargetUPC}_{Display}}^{S} ) ) + ( \sum ( {BUNoPromoVal}_{i = {BRD}_{Display}}^{S} ) - \sum ( {BUNoPromoVal}_{i = {TargetUPC}_{Display}}^{S} ) ) & ( 3.2 .2 .12 .1 ) \\ {BFE}_{i}^{S} = ( \sum ( {PromoVal}_{i = {BRD}_{Feature}}^{S} ) - \sum ( {PromoVal}_{i = {TargetUPC}_{Feature}}^{S} ) ) / ( \sum ( {PromoVal}_{i = {BRD}_{Feature}}^{S} ) - \sum ( {PromoVal}_{i = {TargetUPC}_{Feature}}^{S} ) ) + ( \sum ( {BUNoPromoVal}_{i = {BRD}_{Feature}}^{S} ) - \sum ( {BUNoPromoVal}_{i = {TargetUPC}_{Feature}}^{S} ) ) & ( 3.2 .2 .12 .2 ) \\ {BFD}_{i}^{S} = ( \sum ( {PromoVal}_{i = {BRD}_{FeatureDisplay}}^{S} ) - \sum ( {PromoVal}_{i = {TargetUPC}_{FeatureDisplay}}^{S} ) ) / ( \sum ( {PromoVal}_{i = {BRD}_{FeatureDisplay}}^{S} ) - \sum ( {PromoVal}_{i = {TargetUPC}_{FeatureDisplay}}^{S} ) ) + ( \sum ( {BUNoPromoVal}_{i = {BRD}_{FeatureDisplay}}^{S} ) - \sum ( {BUNoPromoVal}_{i = {TargetUPC}_{FeatureDisplay}}^{S} ) ) & ( 3.2 .2 .12 .3 )\end{matrix}$$

$$\begin{matrix} Appendix B & \\ {ROCRPRV}_{i}^{O} = ( \frac{{RP}_{i}}{\frac{( \sum ( {BaseVal}_{i}^{O} ) - \sum ( {BaseVal}_{i = MFG}^{O} ) )}{( \sum ( {BaseUnits}_{i}^{O} ) - \sum ( {BaseUnits}_{i = MFG}^{O} ) )}} ) & ( 3.2 .3 .1 ) \\ {ROCRPRV}_{i}^{S} = ( \frac{{RP}_{i}}{\frac{( \sum ( {BaseVal}_{i}^{S} ) - \sum ( {BaseVal}_{i = MFG}^{S} ) )}{( \sum ( {BaseUnits}_{i}^{S} ) - \sum ( {BaseUnits}_{i = MFG}^{S} ) )}} ) & ( 3.2 .3 .2 ) \\ {ROMRPRV}_{i}^{O} = ( \frac{{RP}_{i}}{\frac{( \sum ( {BaseVal}_{i = MFG}^{O} ) - \sum ( {BaseVal}_{i = BRD}^{O} ) )}{( \sum ( {BaseUnits}_{i = MFG}^{O} ) - \sum ( {BaseUnits}_{i = BRD}^{O} ) )}} ) & ( 3.2 .3 .3 ) \\ {ROMRPRV}_{i}^{S} = ( \frac{{RP}_{i}}{\frac{( \sum ( {BaseVal}_{i = MFG}^{S} ) - \sum ( {BaseVal}_{i = BRD}^{S} ) )}{( \sum ( {BaseUnits}_{i = MFG}^{S} ) - \sum ( {BaseUnits}_{i = BRD}^{S} ) )}} ) & ( 3.2 .3 .4 ) \\ {ROBRPRV}_{i}^{O} = ( \frac{{RP}_{i}}{\frac{( \sum ( {BaseVal}_{i = BRD}^{O} ) - \sum ( {BaseVal}_{i = TargetUPC}^{O} ) )}{( \begin{matrix}\sum ( {BaseUnits}_{i = BRD}^{O} ) - \\ \sum ( {BaseUnits}_{i = TargetUPC}^{O} )\end{matrix} )}} ) & ( 3.2 .3 .5 ) \\ {ROBRPRV}_{i}^{S} = ( \frac{{RP}_{i}}{\frac{( \sum ( {BaseVal}_{i = BRD}^{S} ) - \sum ( {BaseVal}_{i = TargetUPC}^{S} ) )}{( \begin{matrix}\sum ( {BaseUnits}_{i = BRD}^{S} ) - \\ \sum ( {BaseUnits}_{i = TargetUPC}^{S} )\end{matrix} )}} ) & ( 3.2 .3 .6 )\end{matrix}$$

$$\begin{matrix} Appendix C & \\ {ROCPPI}_{i}^{O} = \frac{( \frac{\sum ( {PromoVal}_{i}^{O} ) - \sum ( {PromoVal}_{i = MFG}^{O} )}{\sum ( {PromoUnits}_{i}^{O} ) - \sum ( {PromoUnits}_{i = MFG}^{O} )} )}{( \frac{\begin{matrix}\sum ( {BUNoPromoVal}_{i}^{O} ) - \\ \sum ( {BUNoPromoVal}_{i = MFG}^{O} )\end{matrix}}{\begin{matrix}\sum ( {BUNoPromoUnits}_{i}^{O} ) - \\ \sum ( {BUNoPromoUnits}_{i = MFG}^{O} )\end{matrix}} )} & ( 3.2 .4 .1 ) \\ {ROCPPI}_{i}^{S} = \frac{( \frac{\sum ( {PromoVal}_{i}^{S} ) - \sum ( {PromoVal}_{i = MFG}^{S} )}{\sum ( {PromoUnits}_{i}^{S} ) - \sum ( {PromoUnits}_{i = MFG}^{S} )} )}{( \frac{\begin{matrix}\sum ( {BUNoPromoVal}_{i}^{S} ) - \\ \sum ( {BUNoPromoVal}_{i = MFG}^{S} )\end{matrix}}{\begin{matrix}\sum ( {BUNoPromoUnits}_{i}^{S} ) - \\ \sum ( {BUNoPromoUnits}_{i = MFG}^{S} )\end{matrix}} )} & ( 3.2 .4 .2 ) \\ {ROMPPI}_{i}^{O} = \frac{( \frac{\sum ( {PromoVal}_{i = MFG}^{O} ) - \sum ( {PromoVal}_{i = BRD}^{O} )}{\begin{matrix}\sum ( {PromoUnits}_{i = MFG}^{O} ) - \\ \sum ( {PromoUnits}_{i = BRD}^{O} )\end{matrix}} )}{( \frac{\begin{matrix}\sum ( {BUNoPromoVal}_{i = MFG}^{O} ) - \\ \sum ( {BUNoPromoVal}_{i = BRD}^{O} )\end{matrix}}{\begin{matrix}\sum ( {BUNoPromoUnits}_{i = MFG}^{O} ) - \\ \sum ( {BUNoPromoUnits}_{i = BRD}^{O} )\end{matrix}} )} & ( 3.2 .4 .3 ) \\ {ROMPPI}_{i}^{S} = \frac{( \frac{\sum ( {PromoVal}_{i = MFG}^{S} ) - \sum ( {PromoVal}_{i = BRD}^{S} )}{\begin{matrix}\sum ( {PromoUnits}_{i = MFG}^{S} ) - \\ \sum ( {PromoUnits}_{i = BRD}^{S} )\end{matrix}} )}{( \frac{\begin{matrix}\sum ( {BUNoPromoVal}_{i = MFG}^{S} ) - \\ \sum ( {BUNoPromoVal}_{i = BRD}^{S} )\end{matrix}}{\begin{matrix}\sum ( {BUNoPromoUnits}_{i = MFG}^{S} ) - \\ \sum ( {BUNoPromoUnits}_{i = BRD}^{S} )\end{matrix}} )} & ( 3.2 .4 .4 ) \\ {ROBPPI}_{i}^{O} = \frac{( \frac{\begin{matrix}\sum ( {PromoVal}_{i = BRD}^{O} ) - \\ \sum ( {PromoVal}_{i = TargetUPC}^{O} )\end{matrix}}{\begin{matrix}\sum ( {PromoUnits}_{i = BRD}^{O} ) - \\ \sum ( {PromoUnits}_{i = TargetUPC}^{O} )\end{matrix}} )}{( \frac{\begin{matrix}\sum ( {BUNoPromoVal}_{i = BRD}^{O} ) - \\ \sum ( {BUNoPromoVal}_{i = TargetUPC}^{O} )\end{matrix}}{\begin{matrix}\sum ( {BUNoPromoUnits}_{i = BRD}^{O} ) - \\ \sum ( {BUNoPromoUnits}_{i = TargetUPC}^{O} )\end{matrix}} )} & ( 3.2 .4 .5 ) \\ {ROBPPI}_{i}^{S} = \frac{( \frac{\begin{matrix}\sum ( {PromoVal}_{i = BRD}^{S} ) - \\ \sum ( {PromoVal}_{i = TargetUPC}^{S} )\end{matrix}}{\begin{matrix}\sum ( {PromoUnits}_{i = BRD}^{S} ) - \\ \sum ( {PromoUnits}_{i = TargetUPC}^{S} )\end{matrix}} )}{( \frac{\begin{matrix}\sum ( {BUNoPromoVal}_{i = BRD}^{S} ) - \\ \sum ( {BUNoPromoVal}_{i = TargetUPC}^{S} )\end{matrix}}{\begin{matrix}\sum ( {BUNoPromoUnits}_{i = BRD}^{S} ) - \\ \sum ( {BUNoPromoUnits}_{i = TargetUPC}^{S} )\end{matrix}} )} & ( 3.2 .4 .6 )\end{matrix}$$

What is claimed is:

1. A computer-implemented method to improve evaluation efficiency of a model, comprising:
identifying, with a processor, a target item to evaluate in connection with historical market activity data; and
improving model evaluation efficiency by optimizing, with the processor, erroneous selection of competitive products by:
identifying a rest-of-category (ROC) subset of items in the historical market activity data that exclude a same manufacturer as the target item;
identifying a rest-of-manufacturer (ROM) subset of items in the historical market activity data that are associated with the same manufacturer as the target item and exclude a same brand as the target item; and
identifying a rest-of-brand (ROB) subset of items in the historical market activity data that are associated with the same brand as the target item and exclude the target item.

2. The computer-implemented method as defined in claim 1, wherein the ROC subset, the ROM subset and the ROB subset encapsulate all competitive items of a category associated with the target item.

3. The computer-implemented method as defined in claim 1, further including identifying competitive measures for the ROC subset, the ROM subset and the ROB subset.

4. The computer-implemented method as defined in claim 3, wherein the competitive measures include a distribution level.

5. The computer-implemented method as defined in claim 1, further including analyzing a candidate product from the historical market activity data for a promotional indicator.

6. The computer-implemented method as defined in claim 5, further including removing over-parameterization errors of the model by preventing promotional terms associated with the candidate product from influencing the model when the promotional indicator is absent.

7. The computer-implemented method as defined in claim 1, further including associating a set of surrogate competitive terms with the ROC subset of items to cause the model to identify, during evaluation by the processor, which ones of the set of surrogate competitive terms affects the target item compared to items in the historical market activity data that are unassociated with the same manufacturer as the target item.

8. The computer-implemented method as defined in claim 7, wherein the set of surrogate competitive terms includes at least one of distribution activity, value on promotion activity, regular price activity or promoted price activity.

9. The computer-implemented method as defined in claim 1, further including associating a set of surrogate competitive terms with the ROM subset of items to cause the model to identify, during evaluation by the processor, which ones of the set of surrogate competitive terms affects the target item compared to items in the historical market activity data that are associated with the same manufacturer and a brand dissimilar to the target item.

10. The computer-implemented method as defined in claim 1, further including associating a set of surrogate competitive terms with the ROB subset of items to cause the model to identify, during evaluation by the processor, which ones of the set of surrogate competitive terms affects the target item compared to items in the historical market activity data that are associated with the same brand as the target item and having alternate features of the target item.

11. The computer-implemented method as defined in claim 1, wherein optimizing erroneous selection of competitive products includes at least one of reducing erroneous selection of competitive products or including a selection of competitive products that exhibit an influence.

12. An apparatus to improve evaluation efficiency of a model, comprising:
a target engine to identify a target item to evaluate in connection with historical market activity data;
a competitor grouping engine to improve model evaluation efficiency by optimizing erroneous selection of competitive products via;
a rest-of-category (ROC) identifier to identify a subset of items in the historical market activity data that exclude a same manufacturer as the target item;
a rest-of-manufacturer (ROM) identifier to identify a subset of items in the historical market activity data that are associated with the same manufacturer as the target item and exclude a same brand as the target item; and
a rest-of-brand (ROB) identifier to identify a subset of items in the historical market activity data that are associated with the same brand as the target item and exclude the target item.

13. The apparatus as defined in claim 12, wherein the ROC subset, the ROM subset and the ROB subset encapsulate all competitive items of a category associated with the target item.

14. The apparatus as defined in claim 12, wherein the competitor grouping engine is to identify competitive measures for the ROC subset, the ROM subset and the ROB subset.

15. The apparatus as defined in claim 14, wherein the competitive measures include a distribution level.

16. The apparatus as defined in claim 12, further including a competitive promotion engine to analyze a candidate product from the historical market activity data for a promotional indicator.

17. A tangible computer readable storage medium comprising instructions that, when executed, causes a processor to, at least:
identify a target item to evaluate in connection with historical market activity data;
improve model evaluation efficiency by optimizing erroneous selection of competitive products by:
identifying a rest-of-category (ROC) subset of items in the historical market activity data that exclude a same manufacturer as the target item;
identifying a rest-of-manufacturer (ROM) subset of items in the historical market activity data that are associated with the same manufacturer as the target item and exclude a same brand as the target item; and
identifying a rest-of-brand (ROB) subset of items in the historical market activity data that are associated with the same brand as the target item and exclude the target item.

18. The machine readable instructions as defined in claim 17, wherein the instructions, when executed, cause the processor to encapsulate all competitive items of a category associated with the target item based on the ROC subset, the ROM subset and the ROB subset.

19. The machine readable instructions as defined in claim 17, wherein the instructions, when executed, cause the processor to identify competitive measures for the ROC subset, the ROM subset and the ROB subset.

20. The machine readable instructions as defined in claim 17, wherein the instructions, when executed, cause the processor to analyze a candidate product from the historical market activity data for a promotional indicator.
